(19) United States
(12) Patent Application Publication
(10) Pub. No.: US 2005/0110652 A1
(43) Pub. Date: May 26, 2005

(54) Method and apparatus for creating and delivering an atomic remote control macro

(75) Inventors: Daniel Otto Becker, Austin, TX (US); Steven Francis Best, Georgetown, TX (US); Michael Richard Cooper, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/718,294

(22) Filed: Nov. 20, 2003

(51) Int. Cl. H04N 5/44

(52) U.S. Cl. 340/825.72; 348/734; 341/176; 340/825.24

(57) ABSTRACT

A method in a signaling device for delivering codes to control multimedia devices. In response to receiving a signal from a remote control device, a macro corresponding to the signal is identified, the identified macro contains a set of codes used to control a set of multimedia devices. The set of codes is transmitted, wherein the set of codes causes a series of events to occur in the set of multimedia devices.

### BACKGROUND OF THE INVENTION

1. Technical Field

The present invention relates generally to an improved data processing system and in particular to a method and apparatus for remotely controlling devices. Still more particularly, the present invention provides a method, apparatus, and computer instructions for controlling devices through a remote control system.

2. Description of Related Art

Devices, such as video and audio components in a home theater system, may be controlled remotely. Each of these devices typically comes with a remote control that is designed to control that particular device. When many devices or components are present, the number of remote controls makes controlling these devices difficult. As a result, many remote controls are designed to allow the control of more than one device. Several techniques are employed to allow a single remote control to control multiple devices. For example, some remote controls are programmed with a series of infra-red (IR) codes for other devices. Further, a “smart” remote control may be used in which this control is configured to learn other remote control IR codes. Additionally, a smart remote control also may have macro and programming capabilities for controlling different components.

In controlling devices, a macro is a series of codes or instructions that are transmitted in response to the selection of the macro for execution through the push of a button. A macro provides a user an ability to perform or initiate a sequence of ordered events across several components through a single button push. The use of macros provides a benefit for users with two or more components in a home theater or entertainment system.

Many programmable remote controls have an ability to allow the user to create a macro through the remote control itself as well as having an interface to allow a macro to be downloaded to the remote control. These macros may be created on and downloaded from a home computer. In this manner, a user may create a complex macro to turn on selected components and set those components to various states to play a movie on the home entertainment system.

With the advantage of using macros, a disadvantage is present. In order for a macro to function correctly, the remote control must be directed or pointed at the set of components for the duration of the macro. In other words, the remote control must be positioned to send codes to the components the entire time the macro is executed. If the direction changes while the macro is running, one or more IR codes may be missed by some of the components in the system. This situation renders the macro useless and may place the home entertainment system into an unknown state. Subsequently, the user either must find the old remote controls for the components and reset the components to a known state or manually reset each of the devices. Larger macros have a greater chance of failure.

For example, with a macro that only powers on and off a set of components, the sequence of codes is unimportant. In another example, the macro may power on a television, a digital versatile disc (DVD) player, and a receiver. In turning on the receiver, a delay of four seconds may be programmed into the macro to allow the receiver to reach the power on state. Thereafter, the macro may then send a code to select an input mode for the receiver and then place the DVD player in a play mode. Execution of the macro may take, for example, five seconds. An unsuspecting user may cause the execution of the macro to fail by pressing the button for the macro and then placing the remote in a place where the remote transmits codes that are not received by the components or the transmission of the codes are blocked by some other source of interference, such as another person walking in front of the remote. As a result, the receiver may be turned on, but the appropriate input may not be selected. In turn, the DVD player may not reach the play mode or the DVD may be played with the receiver using the wrong input.

Therefore, it would be advantageous to have an improved method, apparatus, and computer instructions for creating macros and executing macros in a entertainment system.

### SUMMARY OF THE INVENTION

The present invention provides a method in a signaling device for delivering codes to control multimedia devices. In response to receiving a signal from a remote control device, a macro corresponding to the signal is identified, the identified macro contains a set of codes used to control a set of multimedia devices. The set of codes is transmitted, wherein the set of codes causes a series of events to occur in the set of multimedia devices.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram illustrating components used in creating and executing macros in accordance with a preferred embodiment of the present invention;

FIG. 2 is a diagram illustrating a relay unit in accordance with a preferred embodiment of the present invention;

FIG. 3 is a diagram illustrating functional components for creating and delivering macros in accordance with a preferred embodiment of the present invention; and

FIG. 4 is a flowchart of a process for managing macros in accordance with a preferred embodiment of the present invention.

### DETAILED DESCRIPTION OF THE PREFERRED EMBODIMENT

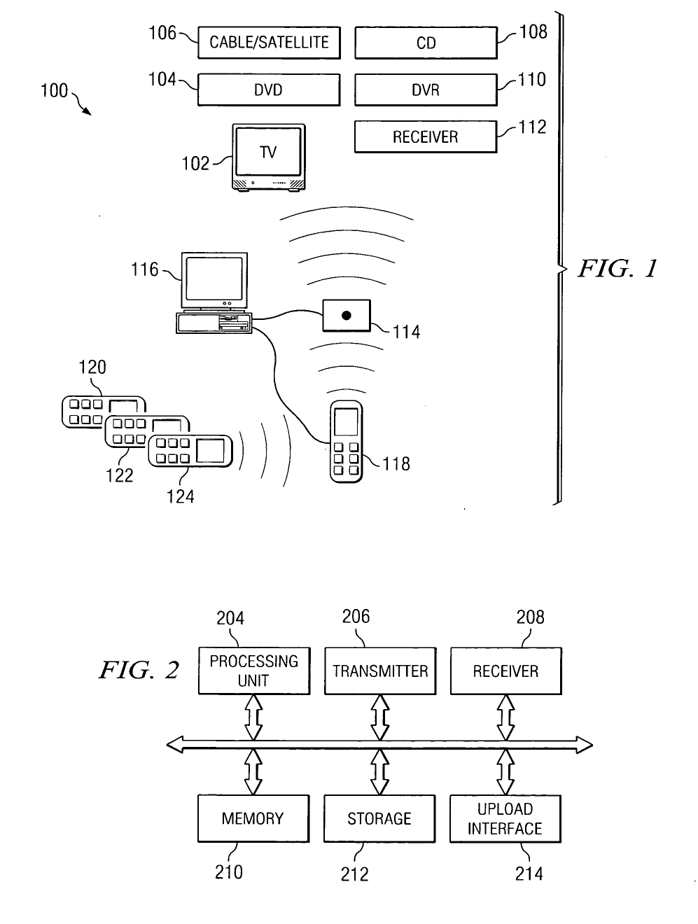

With reference now to the figures and in particular with reference to FIG. 1, a diagram illustrating components used in creating and executing macros is depicted in accordance with a preferred embodiment of the present invention. In this example, home theater system 100 includes TV 102, DVD player 104, cable/satellite receiver 106, compact disc (CD) player 108, digital video recorder (DVR) unit 110, and receiver 112. Home theater system 100 may be any collection of two or more independent devices that are controlled through a single control unit.

Additionally, home theater system 100 also includes relay unit 114. Relay unit 114 may transmit codes to the various components using an IR transmitter and/or a radio frequency (RF) transmitter contained within relay unit 114. Additionally, relay unit 114 may transmit these codes to the various components using other types of protocols, in addition to or in place of IR or RF signals, such as Fire Wire or universal serial bus (USB). Fire Wire is a transfer protocol specified by IEEE 1394. Relay unit 114 is positioned to transmit codes to the different components in home theater system 100. Macros for controlling the components in home theater system 100 are stored within relay unit 114.

These macros may be created and uploaded from different sources. For example, macros may be created within data processing system 116 and uploaded to relay unit 114. Further macros may be obtained using data processing system 116 to access preprogrammed macros from a website. The interface within relay unit 114 may be, for example, through a universal serial bus (USB) or a wireless interface, such as a IR interface.

Alternatively, the macros may be generated at data processing system 116 and then loaded onto remote control 118. In turn, the macro may then be transmitted to relay unit 114 from remote control 118. The transmission of this macro may take place using IR or RF signals, depending on the particular implementation. Further, these macros may be received by remote control 118 from remote controls 120, 122, and 124.

Relay unit 114 may store multiple macros for execution. For example, one macro may cause the transmission of codes to sequentially turn on TV 102, turn on DVD player 104, turn on receiver 112, wait for three seconds, select the DVD input in receiver 112, and then place DVD player 104 into a play mode. Another macro may cause the transmission of codes to turn on TV 102, turn on DVR unit 110, turn on receiver 112, wait for three seconds, and select the DVR input in receiver 112. Each of these macros may be associated with a code or a command that causes execution of the macro by relay unit 114.

In these examples, relay unit 114 acts as an intermediary that receives a single atomic command or code from remote control 118. This code identifies a macro stored within relay unit 114 for execution. In response, relay unit 114 executes the macro identified or selected by remote control 118. Execution of this macro may occur without requiring remote control 118 to be pointed at the different components in home theater system 100. As a result, the user may move or set down remote control 118, while relay unit 114 transmits a series of codes to various components in home theater system 100. As a result, execution of the macro by relay unit 114 completes and the components in home theater system 100 remain in a known state.

With reference now to FIG. 2, a diagram illustrating a relay unit is depicted in accordance with a preferred embodiment of the present invention. This relay unit may be implemented in home theater system 100 as relay unit 114 in FIG. 1. In this example, a bus system is used to interconnect different components within the relay unit.

In this illustrative example, the relay unit includes processing unit 204, transmitter 206, receiver 208, memory 210, storage 212, and upload interface 214 which are all interconnected by the bus system. Processing unit 204 executes instructions used to provide the features of the present invention. These instructions may be located within memory 210. Memory 210 may be, for example, a random access memory (RAM). Macros and instructions for other processes may be stored in storage 212. In these examples, storage 212 may take different forms, such as a hard disc drive or a nonvolatile access memory (NVRAM). These macros and instructions may be loaded into memory 210 for execution by processing unit 204.

Transmitter 206 is used to send codes to different components in a home theater system. In these examples, transmitter 206 may take the form of an IR transmitter. Receiver 208 may receive codes or commands from a remote control, such as remote control 118 in FIG. 1. Upload interface 214 is employed to receive macros and may be, for example, a USB interface or an RF interface. Further, depending on the particular implementation, receivers may be received through receiver 208.

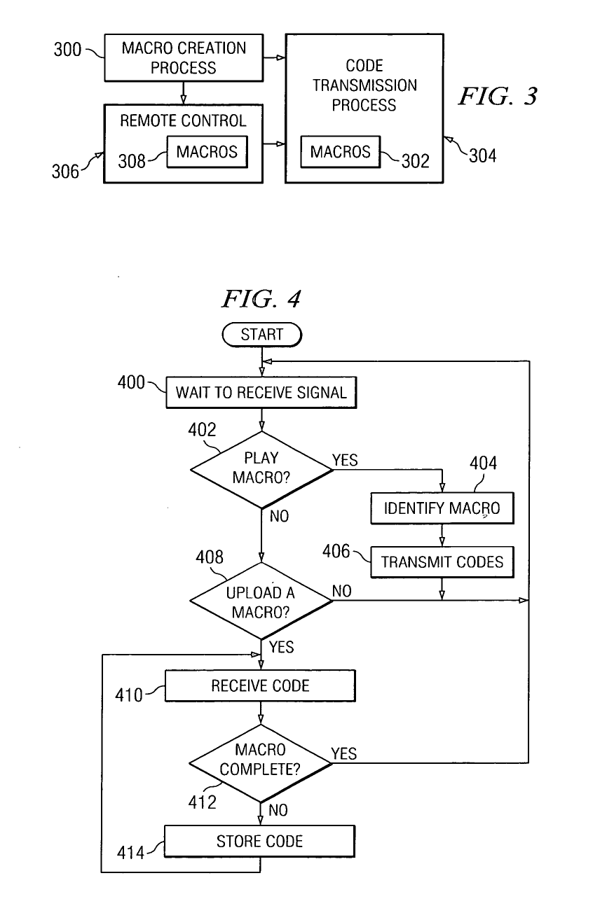

Turning now to FIG. 3, a diagram illustrating functional components for creating and delivering macros is depicted in accordance with a preferred embodiment of the present invention. Macro creation process 300 is used to create macros for use in a home theater system, such as home theater system 100 in FIG. 1. This process may be implemented in a data processing system, such as data processing system 116 in FIG. 1, or in a remote control, such as remote control 118 in FIG. 1. A macro created through macro creation process 300 may be created and stored in macros 302 for code transmission process 304. Code transmission process 304 may be found in a relay unit, such as the relay unit in FIG. 2.

Alternatively, a macro created through macro creation process 300 may be sent to remote control 306 and stored in macros 308. Remote control 306 may be, for example, remote control 118 in FIG. 1. Macros 308 may then be sent to code transmission process 304. When a code or command is received by code transmission process 304, a determination is made as to whether the code or command corresponds to a macro stored in macros 302. If a macro corresponding to the code or command is found, that macro is executed.

Turning now to FIG. 4, a flowchart of a process for managing macros is depicted in accordance with a preferred embodiment of the present invention. The process illustrated in FIG. 4 may be implemented in a process, such as code transmission process 304 in FIG. 3.

The process begins by waiting to receive a signal (step 400). When a signal is received, a determination is made as to whether a macro is to be played or executed (step 402). If the macro is to be played, the macro is identified (step 404), and codes are transmitted (step 406) with the process then returning to step 400.

With reference again to step 402, if the signal does not indicate that the macro is to be played, a determination is made as to whether the signal indicates that a macro is to be uploaded (step 408). If a macro is to be uploaded, a code is received (step 410). In these examples, the code may be received through various interfaces, such as a USB interface or an IR interface. Thereafter, a determination is made as to whether the macro is complete (step 412). The determination in step 412 is made by examining the code received from the source of the macro being uploaded. If the code does not indicate that the macro is complete, this code is then stored as part of the macro (step 414).

With reference again to step 412, if the macro is complete, the process then returns to step 400. Turning back to step 408, if the macro step is not to be uploaded, the process also returns to step 400.

Thus, the present invention provides an improved method, apparatus, and computer instructions for creating and delivering remote control macros. The mechanism of the present invention provides these features through the use of a relay unit. This relay unit receives a command from a remote control to execute a macro. In response to receiving this command, a macro corresponding to the command is identified by the relay unit. In response to identifying the macro, the macro is executed. The execution of this macro may occur without requiring the remote control to remain in a position to transmit codes to the different devices in the home theater system. Instead, the relay unit transmits the codes to the different components in the home theater system. As a result, if the remote control is repositioned or put down while the macro is executing the macro, it may still finish execution because the codes are transmitted by the relay unit.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disc, a hard disc drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a signaling device for delivering codes to control multimedia devices, the method comprising:
responsive to receiving a signal from a remote control device, identifying a macro corresponding to the signal, wherein macro contains a set of codes used to control a set of multimedia devices; and
transmitting the set of codes to the set of multimedia devices, wherein the set of codes causes a series of events to occur in the set of multimedia devices.

2. The method of claim 1, wherein the set of multimedia devices includes at least one of television, a stereo receiver, a stereo amplifier, a digital versatile disc player, a satellite receiver, and a computer.

3. The method of claim 2, wherein the series of events sequentially turns on the television, turns on the stereo receiver, waits for two seconds, and sets an input mode in the stereo receiver.

4. The method of claim 1, wherein transmitting step comprises:
transmitting a series of infra-red signals to transmit the set of codes.

5. The method of claim 1, wherein the transmitting step comprises:
transmitting a set of radio frequency signals to transmit the set of codes.

6. The method of claim 1, further comprising:
responsive to an upload signal, entering an upload mode;
receiving a second macro while in the upload mode; and
storing the second macro, wherein the second macro includes a second set of codes.

7. The method of claim 6, wherein the upload signal is received from one of a computer or the remote control device.

8. The method of claim 1, wherein the signaling device is a relay unit.

9. A data processing system in a signaling device for delivering codes to control multimedia devices, the data processing system comprising:
identifying means, responsive to receiving a signal from a remote control device, for identifying a macro corresponding to the signal, wherein macro contains a set of codes used to control a set of multimedia devices; and
transmitting means for transmitting the set of codes to the set of multimedia devices, wherein the set of codes causes a series of events to occur in the set of multimedia devices.

10. The data processing system of claim 9, wherein the set of multimedia devices includes at least one of television, a stereo receiver, a stereo amplifier, a digital versatile disc player, a satellite receiver, and a computer.

11. The data processing system of claim 10, wherein the series of events sequentially turns on the television, turns on the stereo receiver, waits for two seconds, and sets an input mode in the stereo receiver.

12. The data processing system of claim 9, wherein the transmitting comprises:
means for transmitting a series of infra-red signals to transmit the set of codes.

13. The data processing system of claim 9, wherein the transmitting means comprises:
means for transmitting a set of radio frequency signals to transmit the set of codes.

14. The data processing system of claim 9, further comprising:
entering means, responsive to an upload signal, for entering an upload mode;
receiving means for receiving a second macro while in the upload mode; and
storing means for storing the second macro, wherein the second macro includes a second set of codes.

15. The data processing system of claim 14, wherein the upload signal is received from one of a computer or the remote control device.

16. The data processing system of claim 9, wherein the signaling device is a relay unit.

17. A computer program product in a computer readable medium for delivering codes to control multimedia devices, the computer program product comprising:
first instructions, responsive to receiving a signal from a remote control device, for identifying a macro corresponding to the signal, wherein macro contains a set of codes used to control a set of multimedia devices; and
second instructions for transmitting the set of codes to the set of multimedia devices, wherein the set of codes causes a series of events to occur in the set of multimedia devices.

18. The computer program product of claim 17, wherein the set of multimedia devices includes at least one of television, a stereo receiver, a stereo amplifier, a digital versatile disc player, a satellite receiver, and a computer.

19. The computer program product of claim 18, wherein the series of events sequentially turns on the television, turns on the stereo receiver, waits for two seconds, and sets an input mode in the stereo receiver.

20. A data processing system comprising:
a bus system;
a memory connected to the bus system, wherein the memory includes a set of instructions; and
a processing unit connected to the bus system, wherein the processing unit executes a set of instructions to identify a macro corresponding to the signal, wherein macro contains a set of codes used to control a set of multimedia devices in response to receiving a signal from a remote control device; and transmit the set of codes to the set of multimedia devices, wherein the set of codes causes a series of events to occur in the set of multimedia devices.
